(19) United States
(12) Patent Application Publication
(10) Pub. No.: US 2026/0253098 A1
(43) Pub. Date: Aug. 27, 2026

(54) METHOD FOR PROVIDING REWARD ACCORDING TO ATTENDANCE VERIFICATION, AND SYSTEM THEREFOR

(71) Applicant: WEVERSE COMPANY INC., Seongnam-si, Gyeonggi-do (KR)

(72) Inventor: Sang Il SIM, Seongnam-si, Gyeonggi-do (KR)

(73) Assignee: WEVERSE COMPANY INC., Seongnam-si, Gyeonggi-do (KR)

(21) Appl. No.: 18/874,813

(22) PCT Filed: Jun. 8, 2023
(86) PCT No.: PCT/KR2023/007887

§ 371 Date: Dec. 13, 2024

(30) Foreign Application Priority Data
Jun. 14, 2022 (KR) 10-2022-0072098

(51) Int. Cl. G06Q 30/0207

(52) U.S. Cl. CPC G06Q 30/0224

(57) ABSTRACT

A method for providing a reward according to attendance verification, according to an embodiment of the present disclosure, is a method by which an attendance verification reward application executed by at least one processor of a terminal provides the reward according to the attendance verification, and includes: obtaining ticket information including performance time and performance place information about an offline or online performance event; obtaining activity status information including at least one of from among offline real-time location information and online real-time viewing history information of a user; verifying attendance of the performance event based on the ticket information and the activity status information; and providing a non-fungible token (NFT) reward according to the attendance verification.

### TECHNICAL FIELD

The present disclosure relates to a method for providing a reward according to attendance verification and a system therefor. More specifically, the present disclosure relates to a method and system for providing an NFT reward according to online/offline attendance verification for a predetermined performance event.

### BACKGROUND ART

In modern society, thanks to the ever-evolving information and communications technology (ICT), various performance events (for example, concerts) are actively taking place in spaces that encompass both offline and online.

In this situation, conventionally, in order to encourage more users to participate in events more actively and positively, a service that provides appropriate rewards to users who meet predetermined requirements is being implemented.

For example, there is a service that provides predetermined rewards (for example, predetermined emblems, the right to purchase goods, and/or coupons) when a user verifies that the user attended a predetermined performance event.

However, the aforementioned conventional reward services are mostly focused on offline events, such as verifying the attendance of users by scanning a ticket at an offline venue or by identifying whether the user is located at the offline venue.

Thus, in the conventional method, there is a lack of a technical paradigm for verifying user attendance at online events that have been actively conducted recently.

Accordingly, there is an issue that the accuracy of user attendance verification for performance events that are held both online and offline is significantly low.

In addition, in the conventional technical field, it is common to conduct user attendance verification at offline events in a somewhat one-dimensional manner (for example, scanning a ticket and/or determining whether a user is located at the venue). Hence, there is a limitation in that it is difficult to distinguish users who did not fully participate in an event, such as when a user only performs attendance verification at an offline venue and leaves the venue without viewing the performance event. This further reduces the reliability of the event attendance verification.

In addition, conventional reward services only provide conventional forms of rewards (for example, emblems or coupons) that follow a universal reward system, which limits their ability to satisfy reward satisfaction of users.

Accordingly, the need for development and introduction of a differentiated reward system that may more effectively improve reward satisfaction of users is increasing.

With the recent groundbreaking development of blockchain technology, the utilization of non-fungible tokens (NFTs) based thereon is expanding into various fields.

Herein, the NFT refers to a virtual token that proves the ownership of a digital asset using blockchain technology.

In detail, the NFT may be a type of virtual certificate of authenticity used to indicate its unique originality and ownership by including an address indicating a digital file, such as a predetermined image, video, and/or audio, in a token.

In other words, the NFT may mean a unique digital file format registered on a blockchain, and such NFT has the advantage that its economic value may gradually increase over time, so interest in the NFT is also increasing.

### DETAILED DESCRIPTION OF INVENTION

### Technical Problems

The present disclosure has been devised to obviate the above limitation of the related art. An aspect of the present disclosure is directed to implementing a method and system for providing NFT rewards according to online/offline attendance verification for a predetermined performance event.

### Technical Solution

A method for providing a reward according to attendance verification, according to an embodiment of the present disclosure, is a method by which an attendance verification reward application executed by at least one processor of a terminal provides the reward according to the attendance verification, and includes: obtaining ticket information including performance time and performance place information about an offline or online performance event; obtaining activity status information including at least one of from among offline real-time location information and online real-time viewing history information of a user; verifying attendance of the performance event based on the ticket information and the activity status information; and providing a non-fungible token (NFT) reward according to the attendance verification.

In this connection, the NFT reward is a reward provided based on an NFT, a digital file registered on a blockchain.

In addition, the verification of the attendance of the performance event includes verifying the attendance based on verification conditions including a participation place condition that sets a target place for approving the attendance verification for the performance event, and a participation time condition that sets a target viewing time for approving the attendance verification for the performance event.

In addition, the verification of the attendance of the performance event includes verifying offline attendance based on the ticket information, the real-time location information, and the verification conditions when the performance event is an offline performance event, and verifying online attendance based on the ticket information, the real-time viewing history information, and the verification conditions when the performance event is an online performance event.

In addition, the provision of the NFT reward according to the attendance verification includes creating the NFT reward including predetermined digital content.

In addition, the provision of the NFT reward according to the attendance verification further includes providing an offline customized NFT reward according to the attendance verification for the offline performance event, and the creation of the NFT reward including the digital content includes creating the offline customized NFT reward based on user-specific digital content including a video captured targeting a user who attended the offline performance event.

In addition, the method for providing the reward according to the attendance verification according to an embodiment of the present disclosure further includes providing a new NFT reward according to a plurality of pieces of attendance verification.

In addition, the provision of the new NFT reward according to the plurality of pieces of attendance verification includes providing a predetermined additional NFT reward when the plurality of pieces of attendance verification based on a plurality of pre-designated performance events are approved.

In addition, the provision of the new NFT reward according to the plurality of pieces of attendance verification includes providing an upgrade function for synthesizing a plurality of NFT rewards provided according to the plurality of pieces of attendance verification approved according to a predetermined criterion, and providing a predetermined higher-tier NFT reward when the synthesis is successful.

In addition, the method for providing the reward according to the attendance verification according to an embodiment of the present disclosure further includes verifying the attendance based on verification basic conditions including minimum attendance verification requirements, and performing capturing control to restrict or permit camera capturing when the attendance verification according to the verification basic conditions is approved.

In addition, the performance of the capturing control includes performing the capturing control based on a preset capturing restriction section.

In addition, the provision of the NFT reward according to the attendance verification includes creating the NFT reward including a user personal video captured in a section other than the capturing restriction section.

A system for providing a reward according to attendance verification according to an embodiment of the present disclosure includes: at least one memory in which an attendance verification reward application is stored; and at least one processor for reading out the attendance verification reward application stored in the memory and providing the reward according to the attendance verification; wherein instructions of the attendance verification reward application include instructions for: obtaining ticket information including performance time and performance place information about an offline or online performance event; obtaining activity status information including at least one of from among offline real-time location information and online real-time viewing history information of a user; verifying attendance of the performance event based on the ticket information and the activity status information; and providing a non-fungible token (NFT) reward according to the attendance verification.

### Effect of Invention

A method for providing a reward according to attendance verification and a system therefor according to an embodiment of the present disclosure can verify user attendance for performance events held online and offline, thereby clearly identifying the user attendance and viewing not only of offline but also online performance events, and thereby improving the accuracy and reliability of user attendance verification for the performance events held in spaces encompassing online and offline.

In addition, the method for providing the reward according to the attendance verification and the system therefor according to an embodiment of the present disclosure can implement a differentiated reward paradigm that can more effectively increase user satisfaction with rewards by providing a predetermined NFT reward according to the approval of the attendance verification, thereby further encouraging user participation in performance events and thereby promoting the activation of the performance market.

In addition, the method for providing the reward according to the attendance verification and the system therefor according to an embodiment of the present disclosure can provide customized NFT rewards specialized for each user, thereby further improving user satisfaction with rewards and simultaneously increasing user needs and desires for participation in performance events, thereby inducing more active performance viewing.

### BRIEF DESCRIPTION OF THE DRAWING

FIG. 1 is a conceptual diagram illustrating a system for providing a reward according to attendance verification according to an embodiment of the present disclosure.

FIG. 2 is an internal block diagram illustrating a terminal according to an embodiment of the present disclosure.

FIG. 3 is a flowchart illustrating a method for providing a reward according to attendance verification according to an embodiment of the present disclosure.

FIG. 4 is a conceptual diagram illustrating a method for performing on/offline attendance verification based on ticket information and activity status information according to an embodiment of the present disclosure.

FIG. 5 is an example of user-specific digital content according to an embodiment of the present disclosure.

FIG. 6 is a conceptual diagram illustrating a method for providing a new reward according to an embodiment of the present disclosure.

### BEST MODE FOR CARRYING OUT THE INVENTION

Embodiments of the present disclosure will be shown in the drawings and described in detail through a detailed description. However, the present disclosure may be variously modified and embodied in a variety of different embodiments. Advantages and features of the present disclosure and implementation methods thereof will be clarified through the following embodiments described with reference to the accompanying drawings. Therefore, the present disclosure is not limited to these embodiments introduced hereinafter and might be embodied in a different shape from these embodiments. The terms “first,” “second,” and so on in the present disclosure are used for distinguishing one component from the other components, but they do not specify limited meanings. Also, the singular forms used in the present disclosure are intended to include the plural forms, unless the context clearly indicates otherwise. Moreover, the terms “comprises” and/or “having” described in the present disclosure specify the presence of stated components and/or features, but do not preclude the presence or addition of one or more other components and/or features. Furthermore, the size or the thickness of each component in the drawings can be exaggerated or reduced for the definiteness of explanation. For example, the size and the thickness of each component in the drawings are arbitrarily represented for the convenience of explanation. In accordance therewith, the present disclosure is not limited to the matters shown in the drawings.

Reference will now be made in detail to the embodiments of the present disclosure with reference to the accompanying drawings. Wherever possible, the same reference numbers will be used throughout the disclosure including the drawings to refer to the same or like parts. As such, the repeatable description of the same or like parts will be omitted.

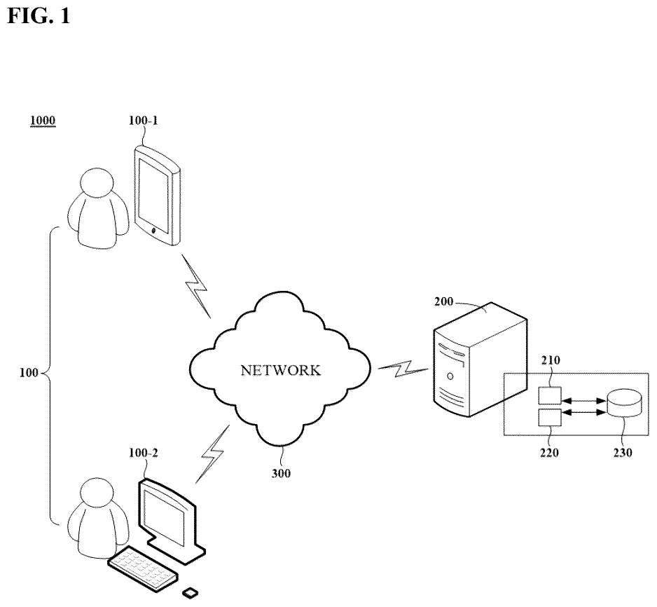

FIG. 1 is a conceptual diagram illustrating a system for providing a reward according to attendance verification according to an embodiment of the present disclosure.

Referring to FIG. 1 a system 1000 for providing a reward according to attendance verification according to an embodiment of the present disclosure may implement an attendance verification reward service that provides an NFT reward according to on/offline attendance verification for a predetermined performance event.

In an embodiment, the system 1000 for providing the reward according to the attendance verification implementing the attendance verification reward service as described above may include a terminal 100, a service providing server 200, and a network 300.

In this connection, the terminal 100 and the service providing server 200 may be connected through the network 400.

Herein, the network 300 according to an embodiment refers to a connection structure capable of exchanging information between nodes such as the terminal 100 and/or the service providing server 200. Examples of the network 300 include 3GPP (3 rd Generation Partnership Project) network, LTE (Long Term Evolution) network, WIMAX (World Interoperability for Microwave Access) network, Internet, LAN (Local Area Network), Wireless LAN (Wireless Local Area Network), WAN (Wide Area Network), PAN (Personal Area Network), Bluetooth network, Satellite Broadcasting Network, Analog Broadcasting Network, and DMB (Digital Multimedia Broadcasting) network, but are not limited thereto.

Hereinafter, the terminal 100 and the service providing server 200 implementing the system 1000 for providing the reward according to the attendance verification will be described in detail with reference to the attached drawings.

### Terminal 100

The terminal 100 according to an embodiment of the present disclosure may be a predetermined computing device having an attendance verification reward application (hereinafter, an “application”) installed that provides the attendance verification reward service.

Specifically, from a hardware point of view, the terminal 100 may include a mobile-type computing device 100-1 and/or a desktop-type computing device 100-2 in which the application is installed.

Herein, the mobile-type computing device 100-1 may be a mobile device such as a smartphone or tablet PC in which the application is installed.

For example, the mobile-type computing device 100-1 may include a smartphone, a mobile phone, a digital broadcasting terminal 100, a personal digital assistant (PDA), a portable multimedia player (PMP), and a tablet PC.

In addition, the desktop-type computing device 100-2 may include a device installed with a program to execute the attendance verification reward service based on wired/wireless communication such as a fixed-type desktop PC, a laptop computer, and a personal computer such as an ultrabook in which the application is installed.

In addition, according to an embodiment, the terminal 100 may further include a predetermined server computing device that provides an attendance verification reward service environment.

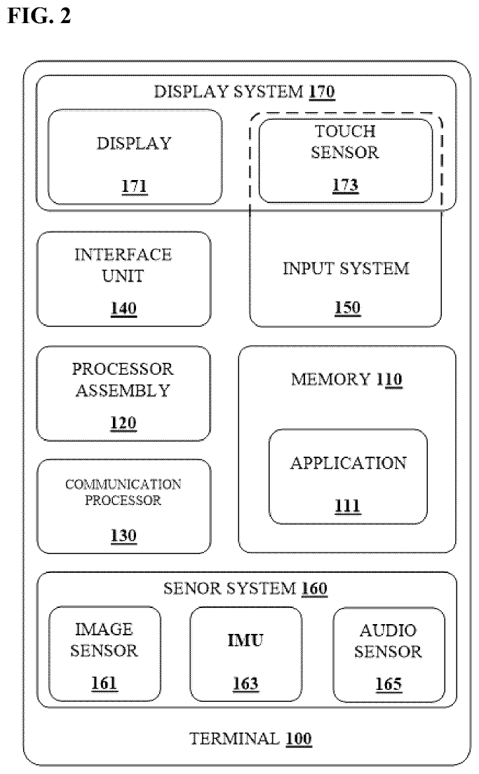

FIG. 2 is an internal block diagram of the terminal 100 according to an embodiment of the present disclosure.

Referring to FIG. 2, from a functional point of view, the terminal 100 may include a memory 110, a processor assembly 120, a communication processor 130, an interface unit 140, an input system 150, a sensor system 160, and a display system 170. These components may be configured to be included within a housing of the terminal 100.

Specifically, the memory 110 may store an application 111, and the application 111 may store one or more of various application programs, data, and instructions for providing the attendance verification reward service environment.

In other words, the memory 110 may store commands and data used for creating the attendance verification reward service environment.

In addition, the memory 110 may include a program area and a data area.

Herein, the program area according to an embodiment may be linked between an operating system (OS) for booting the terminal 100 and functional elements, and the data area may store data generated according to the use of the terminal 100.

In addition, the memory 110 may include at least one non-transitory computer-readable storage medium and a temporary computer-readable storage medium.

For example, the memory 110 may be various storage devices, such as a ROM, an EPROM, a flash drive, and a hard drive; and may be a web storage performing a storage function of the memory 110 on the Internet.

The processor assembly 120 may include at least one processor capable of executing commands of the application 111 stored in the memory 110 to perform various tasks for creating the attendance verification reward service environment.

In an embodiment, the processor assembly 120 may control the overall operation of components through the application 111 of the memory 110 in order to provide the attendance verification reward service.

The processor assembly 120 may be a system-on-chip (SOC) suitable for the terminal 100 that includes a central processing unit (CPU) and/or graphics processing unit (GPU), may execute the OS and/or an application program stored in the memory 110, and control each component mounted on the terminal 100.

In addition, the processor assembly 120 may communicate with each component internally through a system bus and may include one or more predetermined bus structures including a local bus.

In addition, the processor assembly 120 may be implemented by using at least one of application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or electric units for performing other functions.

The communication processor 130 may include one or more devices for communicating with an external device. The communication processor 130 may communicate through a wireless or wired network.

In detail, the communication processor 130 may communicate with the terminal 100 storing a content source for implementing the attendance verification reward service environment, and may communicate with various user input components such as a controller receiving a user input.

In an embodiment, the communication processor 130 may transmit/receive various pieces of data related to the attendance verification reward service to/from another terminal 100 and/or an external server.

This communication processor 130 may wirelessly transmit and receive data with at least one of a base station, an external terminal 100, or an arbitrary server on a mobile communication network built through a communication device capable of performing technical standards or communication methods (for example, LTE (Long Term Evolution), LTE-A (Long Term Evolution-Advanced), 5G NR (New Radio), and WIFI) or short-range communication methods for mobile communication.

The sensor system 160 may include various sensors such as an image sensor 161, a position sensor (IMU) 163, an audio sensor 165, a distance sensor, a proximity sensor, and a contact sensor.

Herein, the image sensor 161 may capture an image and/or a video of a physical space around the terminal 100.

In an embodiment, the image sensor 161 may capture and acquire various images and/or videos related to the attendance verification reward service.

In an embodiment, the image sensor 161 may acquire a captured image of an actual ticket image and/or a user personal image.

In addition, the image sensor 161 may be disposed on the front or/and rear side of the terminal 100 to acquire an image by capturing the disposed direction side, and may capture a physical space through a camera disposed toward the outside of the terminal 100.

The image sensor 161 may include an image sensor device and a video processing module. Specifically, the image sensor 161 may process a still image or a moving image obtained by an image sensor device (for example, CMOS or CCD).

In addition, the image sensor 161 may process a still image or a moving image obtained through the image sensor device using an image processing module to extract necessary information, and transmit the extracted information to a processor.

The image sensor 161 may be a camera assembly including at least one or more cameras. The camera assembly may include a general camera that captures a visible light band, and may further include a special camera such as an infrared camera or a stereo camera.

In addition, the aforementioned image sensor 161 may be operated while being included in the terminal 100 according to an embodiment, or may be included in an external device (for example, an external server) to operate through interworking based on the aforementioned communication processor 130 and/or interface unit 140.

The IMU 163 may sense at least one of motion and acceleration of the terminal 100. For example, the IMU 163 may include a combination of various position sensors such as an accelerometer, a gyroscope, and a magnetometer.

In addition, the IMU may interwork with the position communication processor 130 such as GPS of the communication processor 130 to recognize spatial information on the physical space around the terminal 100.

The audio sensor 165 may recognize a sound around the terminal 100.

In detail, the audio sensor 165 may include a microphone capable of sensing a speech input of a user using the terminal 100.

In an embodiment, the audio sensor 165 may receive speech data necessary for the attendance verification reward service from a user.

The interface unit 140 may communicatively connect the terminal 100 with one or more other devices. Specifically, the interface unit 140 may include wired and/or wireless communication devices that are compatible with one or more different communication protocols.

The terminal 100 may be connected to various input/output devices through the interface unit 140.

For example, the interface unit 140 may be connected to an audio output device such as a headset port or a speaker to output audio.

Although it has been described as an example that the audio output device is connected through the interface unit 140, an embodiment in which the audio output device is installed in the terminal 100 may also be included.

In addition, for example, the interface unit 140 may be connected to an input device such as a keyboard and/or mouse to acquire a user input.

This interface unit 140 may include at least one of a wired/wireless headset port, an external charger port, a wired/wireless data port, a memory card port, a port for connecting a device equipped with an identification module, an audio input/output (I/O) port, a video I/O port, an earphone port, a power amplifier, an RF circuit, a transceiver or other communication circuits.

The input system 150 may sense a user input (for example, a gesture, a speech command, operation of a button, or other type of input) related to the attendance verification reward service.

Specifically, the input system 150 may include a predetermined button, a touch sensor, and/or an image sensor 161 that receives a user motion input.

In addition, the input system 150 may be connected to an external controller through the interface unit 140 to receive a user input.

The display system 170 may output various pieces of information related to the attendance verification reward service as a graphic image.

In an embodiment, the display system 170 may display various user interfaces for the attendance verification reward service.

Such display may include at least one of a liquid crystal display (LCD), a thin film transistor-liquid crystal display (TFT LCD), an organic light-emitting diode (OLED), and a flexible display, a 3D display, or an electronic ink display (e-ink display).

The above components may be disposed within the housing of the terminal 100, and a user interface may include a touch sensor 173 on a display 171 configured to receive a user touch input.

In detail, the display system 170 may include the display 171 that outputs an image and the touch sensor 273 that senses a user touch input.

For example, the display 171 may form an overlaid structure with the touch sensor 173 or integrally formed to be implemented as a touch screen. Such a touch screen may function as a user input unit that provides an input interface between the terminal 100 and the user, and may provide an output interface between the terminal 100 and the user.

In addition, according to an embodiment, the terminal 100 may further perform at least a portion of functional operations performed by the service providing server 200, which will be described later.

### Service Providing Server 200

The service providing server 200 according to an embodiment of the present disclosure may perform a series of processes for providing the attendance verification reward service.

In detail, in an embodiment, the service providing server 200 may provide the attendance verification reward service by exchanging data necessary to enable for a reward process according to the attendance verification for a predetermined performance event to drive in an external device such as the terminal 100 with the external device.

In more detail, in an embodiment, the service providing server 200 may provide an environment in which the application 111 may operate in an external device (in an embodiment, the mobile-type computing device 100-1 and/or the desktop-type computing device 100-2).

To this end, the service providing server 200 may include application programs, data and/or instructions for the application 111 to operate, and may transmit and receive various pieces of data based thereon with the external device.

In addition, in an embodiment, the service providing server 200 may register and store ticket information for a predetermined performance event on an attendance verification reward service platform.

Herein, the ticket information according to an embodiment is data that provides various pieces of information based on a ticket that proves the qualification to view a predetermined on/offline performance event (for example, a concert). In an embodiment, such ticket information may include the performance event name, performance time, performance place (performance space), viewing seat information, and/or ticket identification information (for example, a predetermined QR code, barcode, and/or serial number) for a predetermined on/offline performance event.

In addition, in an embodiment, the service providing server 200 may obtain and monitor activity status information for a user.

Herein, the activity status information according to an embodiment may mean data including the real-time offline location information and/or real-time online viewing history information of a user.

In addition, in an embodiment, the service providing server 200 may verify attendance based on the ticket information and the activity status information.

In other words, in an embodiment, the service providing server 200 may verify attendance to verifies that a user has appropriately participated in and viewed the performance event according to the ticket information based on the ticket information and the activity status information.

In addition, in an embodiment, the service providing server 200 may perform capturing control based on the attendance verification as described above.

In detail, in an embodiment, the service providing server 200 may perform capturing control to restrict or permit capturing by controlling the image sensor 161 included in the terminal 100 when the attendance verification is approved in conjunction with the terminal 100 of a user.

In addition, in an embodiment, the service providing server 200 may provide a predetermined reward according to the attendance verification.

In this connection, in an embodiment, the reward may be implemented as a reward based on a non-fungible token (NFT).

In addition, in an embodiment, the service providing server 200 may provide a new reward according to a plurality of pieces of attendance verification.

Herein, the new reward according to an embodiment may mean a predetermined reward newly obtained as the plurality of pieces of attendance verification are approved.

In addition, in an embodiment, the service providing server 200 may store and manage various application programs, instructions, and/or data for implementing the attendance verification reward service.

As an example, the service providing server 200 may store and manage at least one or more pieces of ticket information, activity status information, verification conditions, capturing restriction section information, NFT, user-specific digital content, and/or various user interfaces.

However, in an embodiment of the present disclosure, the functional operations that the service providing server 200 may perform are not limited to those described above, and other functional operations may be performed.

Referring further to FIG. 1, in an embodiment, the service providing server 200 as described above may be implemented as a predetermined computing device including at least one processor module 210 for data processing, at least one communication module 220 for data exchange with an external device, and at least one memory module 230 for storing various application programs, data, and/or instructions for providing the attendance verification reward service.

Herein, the memory module 230 may store one or more of an operating system (OS), various application programs, data, or instructions for providing the attendance verification reward service.

In addition, the memory module 230 may include the program area and the data area.

Herein, the program area according to an embodiment may be linked between the OS for booting a server and functional elements, and the data area may store data generated according to the use of the server.

In an embodiment, the memory module 230 may be various storage devices, such as a ROM, a RAM, an EPROM, a flash drive, and a hard drive, and may be a web storage performing a storage function of the memory module 230 on the Internet.

In addition, the memory module 230 may be a detachable recording medium on a server.

The processor module 210 may control the overall operation of each unit to implement the attendance verification reward service.

The processor module 210 may be the SOC suitable for the server that includes the CPU and/or GPU, may execute the OS and/or an application program stored in the memory module 230, and control each component mounted on the server.

In addition, the processor module 210 may communicate with each component internally through a system bus and may include one or more predetermined bus structures including a local bus.

In addition, the processor module 210 may be implemented by using at least one of the ASICs, DSPs, DSPDs, PLDs, FPGAs, controllers, micro-controllers, microprocessors, or electric units for performing other functions.

In the above description, it has been described that the service providing server 200 according to an embodiment of the present disclosure performs the functional operation as described above. However, according to an embodiment, various embodiments may be possible, such as performing at least a portion of the functional operation performed by the service providing server 200 (for example, the terminal 100), and further performing at least a portion of the functional operation performed in the external device in the service providing server 200.

### Method for Providing Reward according to Attendance Verification

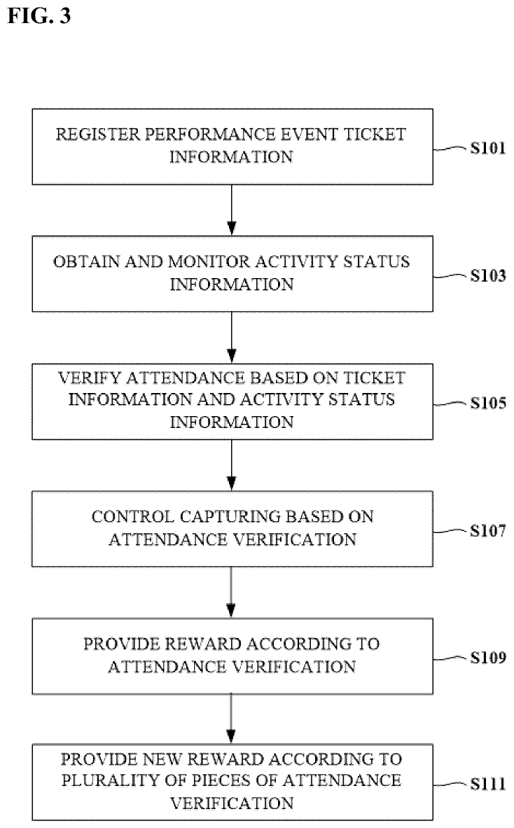

Hereinafter, a method for providing a reward according to attendance verification by the application 111 executed by at least one processor of the terminal 100 according to an embodiment of the present disclosure will be described in detail with reference to the attached FIGS. 3 to 6.

In an embodiment of the present disclosure, the at least one processor of the terminal 100 may execute at least one application 111 stored in at least one memory 110 or operate the same in a background state.

Hereinafter, the method for providing the attendance verification reward service described above by having the at least one processor operate to execute instructions of the application 111 is briefly described as being performed by the application 111.

FIG. 3 is a flowchart illustrating a method for providing a reward according to attendance verification according to an embodiment of the present disclosure.

Referring to FIG. 3, in an embodiment, the application 111 executed by the at least one processor of the terminal 100 or operating in a background state may register ticket information for a predetermined performance event (S101).

Herein, the ticket information according to an embodiment may be data that provides various pieces of information based on a ticket that proves the qualification to view a predetermined on/offline performance event (for example, concert).

In an embodiment, such ticket information may include a performance event name, performance time (for example, from a predetermined time to a predetermined time), performance place (performance space), viewing seat information, and/or ticket identification information (for example, a predetermined QR code, barcode, and/or serial number) for a predetermined on/offline performance event.

In this connection, in an embodiment, the performance event may include an offline performance conducted offline and/or an online performance conducted online.

In the case of the offline performance, the performance place may be determined based on a specific space (for example, a first concert hall or a first park) corresponding to a predetermined offline address, and in the case of the online performance, the performance place (performance space) may be determined based on a virtual space (for example, a first video streaming platform room) corresponding to a specific online Internet address.

In detail, in an embodiment, the application 111 may register and store ticket information for a predetermined on/offline performance event by matching the same with a user account on the attendance verification reward service platform.

In an embodiment, the application 111 may register and store the ticket information by matching the same to a corresponding user account based on user input, optical character recognition (OCR) based on a physical ticket, and/or linkage with an external server (for example, a ticket sales server).

In addition, in an embodiment, the application 111 may obtain and monitor activity status information about a user (S103).

Herein, the activity status information according to an embodiment may mean data including the real-time location information and/or real-time viewing history information of a user.

In detail, in an embodiment, when the performance event is an offline performance, the application 111 may obtain real-time location information, which is information that tracks the real-time current location of a user, by linking with the sensor system 160 and/or the communication processor 130.

Alternatively, in an embodiment, when the performance event is an online performance, the application 111 may obtain the Internet address where the online performance is held based on the performance place (performance space) information of the ticket information.

In addition, in an embodiment, the application 111 may obtain the real-time viewing history information of a user by linking with a server (hereinafter, online performance providing server) whose domain is the obtained Internet address.

In this connection, the real-time viewing history information according to an embodiment may be information that monitors the Internet address of the performance place (performance space) and the real-time access/presence (location) status of the corresponding user for the performance place (performance space).

In addition, in an embodiment, the application 111 may obtain the activity status information including real-time location information and/or real-time viewing history information obtained as described above.

In addition, in an embodiment, the application 111 may continuously monitor the activity status information of a user.

Thus, the application 111 may easily determine in real time whether the user is properly attending the relevant performance event and viewing the performance.

In addition, in an embodiment, the application 111 may verify attendance based on the ticket information and the activity status information (S105).

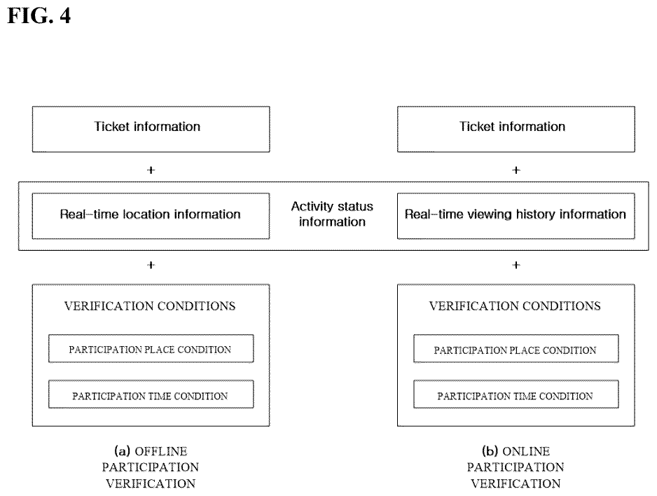

FIG. 4 is a conceptual diagram illustrating a method for performing on/offline attendance verification based on ticket information and activity status information according to an embodiment of the present disclosure.

In detail, referring to FIG. 4, in an embodiment, the application 111 may verify attendance to verify that a user has appropriately participated in and viewed a performance event (hereinafter, target performance event) according to the ticket information based on the ticket information and activity status information obtained as described above.

In more detail, in an embodiment, the application 111 may verify user attendance according to the ticket information and activity status information based on preset verification conditions.

In this connection, the verification conditions according to an embodiment may include a participation place condition that sets a target place that allows approval of attendance verification of a user for the target performance event, and a participation time condition that sets a target viewing time that allows approval of attendance verification of a user for the target performance event.

For example, the participation place conditions may be determined based on the performance place of the target performance event (in other words, the performance place (performance space) according to the ticket information, hereinafter referred to as the main target place) and/or a separately designated target place (hereinafter referred to as the designated target place).

In this connection, for example, the designated target place may be a range within a predetermined radius based on the main target place.

In addition, as an example, the participation time condition may be determined based on the performance time of the target performance event (in other words, the performance time according to the ticket information, hereinafter referred to as the main viewing time) and/or a separately designated target viewing time (hereinafter referred to as the designated viewing time).

For example, the designated viewing time may be a predetermined period of time from the start time of the performance based on the main viewing time to the time after a predetermined period of time (for example, 1 hour) has elapsed, or a predetermined period of time within the main viewing time (for example, a period of time of a specific section included in the main viewing time).

Returning again, specifically in an embodiment, when the target performance event is an offline performance, the application 111 may verify 1) offline attendance based on the ticket information, the activity status information, and the verification conditions.

In detail, in an embodiment, the application 111 may extract real-time location information from the activity status information for the offline attendance verification.

In addition, in an embodiment, the application 111 may perform a first requirement determination to determine whether the conformity degree between the extracted real-time location information and the participation location conditions within the verification conditions satisfies a predetermined criterion (for example, a conformity degree higher than a preset level).

Specifically, in an embodiment, the application 111 may perform the first requirement determination by comparing the extracted real-time location information with the target place according to the participating place condition in the verification condition.

For example, the application 111 may perform the first requirement determination to compare an offline address according to the real-time location information with an offline address for the target place to determine the conformity degree.

In addition, in an embodiment, when it is determined that the real-time location information and the target place have a conformity degree that satisfies a predetermined criterion as a result of the first requirement determination, the application 111 may calculate the viewing time (hereinafter, cumulative viewing time) while the first requirement determination is satisfied.

In other words, in an embodiment, the application 111 may calculate the cumulative viewing time, which is the elapsed time while a user stays at the target place that approves attendance verification for the target performance event held offline.

As an example, the application 111 may calculate the elapsed time from the time at which the first requirement is determined to be satisfied to the time at which the first requirement is determined to be unsatisfied as the cumulative viewing time.

In addition, in an embodiment, the application 111 may perform a second requirement determination to determine whether the conformity degree between the calculated cumulative viewing time and the participation time condition within the verification conditions satisfies a predetermined criterion (for example, a conformity degree higher than a preset level).

In detail, in an embodiment, the application 111 may perform the second requirement determination by comparing the calculated cumulative viewing time with the target viewing time according to the participation time condition in the verification conditions.

In addition, in an embodiment, when it is determined that the cumulative viewing time and the target viewing time have a conformity degree that satisfies a predetermined criterion as a result of the second requirement determination, the application 111 may approve the offline attendance verification.

For example, when the calculated cumulative viewing time is “14:00 to 16:00,” the target viewing time of the participation time condition is “14:00 to 16:00,” and the predetermined criterion is “a conformity degree of 80% or higher,” the application 111 may perform approval processing for the corresponding offline attendance verification.

As such, the application 111 may easily identify whether a user attended and viewed an offline performance based on reasonable/objective basis data by verifying the attendance of the user at the offline performance based on the offline performance ticket information and the real-time location and time of stay of the user.

In an embodiment, when the target performance event is an online performance, the application 111 may perform 2) online attendance verification based on the ticket information, the activity status information, and the verification conditions.

Hereinafter, any explanation that overlaps with the above may be summarized or omitted.

In detail, in an embodiment, the application 111 may extract real-time viewing history information in the activity status information for the online attendance verification.

In this connection, the real-time viewing history information may be collected, obtained, and updated in real time from the online performance providing server described above.

In addition, in an embodiment, the application 111 may perform the first requirement determination to determine whether the conformity degree between the extracted real-time viewing history information and the participation place conditions within the verification conditions satisfies a predetermined criterion (for example, a conformity degree higher than a preset level).

In more detail, in an embodiment, the application 111 may perform the first requirement determination by comparing the Internet address corresponding to the extracted real-time viewing history information with the target place according to the participation place condition in the verification condition.

For example, the application 111 may perform the first requirement determination to compare the Internet address according to the real-time viewing history information with the Internet address according to the target place and determine the conformity degree.

In addition, in an embodiment, when it is determined that the real-time viewing history information and the target place have a conformity degree that satisfies a predetermined criterion as a result of the first requirement determination, the application 111 may obtain the cumulative viewing time while satisfying the first requirement determination based on the real-time viewing history information.

In other words, in an embodiment, the application 111 may obtain the cumulative viewing time, which is the elapsed time while a user is present at the target place that approves attendance verification for the target performance event held online, based on the real-time viewing history information.

As an example, the application 111 may obtain the cumulative viewing time based on the real-time connection/presence (location) status information of a user included in the real-time viewing history information.

In addition, in an embodiment, the application 111 may perform the second requirement determination to determine whether the conformity degree between the cumulative viewing time obtained as described above and the participation time condition within the verification conditions satisfies a predetermined criterion (for example, a conformity degree higher than a preset level).

In detail, in an embodiment, the application 111 may perform the second requirement determination by comparing the obtained cumulative viewing time with the target viewing time according to the participation time condition in the verification condition.

In addition, in an embodiment, when it is determined that the cumulative viewing time and the target viewing time have a conformity degree that satisfies a predetermined criterion as a result of the second requirement determination, the application 111 may approve the online attendance verification.

For example, when the obtained cumulative viewing time is “12:00 to 15:00,” the target viewing time of the participation time condition is “12:00 to 14:00,” and the predetermined criterion is “a conformity degree of 50% or higher,” the application 111 may perform approval processing for the corresponding offline attendance verification.

As such, the application 111 verifies the attendance of a user for an online performance based on the ticket information for viewing the online performance and the real-time viewing history information of a user (in other words, information monitoring the access/presence status on a specific Internet page of the user where the online performance is being held in an embodiment), thereby accurately confirming the attendance and viewing of the user not only of offline but also online performance events using reliable base data.

In addition, in an embodiment, the application 111 may perform capturing control based on the attendance verification (S107).

Generally, most performance events frequently involve situations where capturing of the performance event needs to be restricted while the performance event is taking place due to copyright or security reasons.

To effectively deal with this situation, in an embodiment of the present disclosure, the application 111 may perform capturing control according to the attendance verification of a user. Hereinafter, any description that overlaps with the above may be summarized or omitted.

In detail, in an embodiment, the application 111 may verify the attendance of a user for the target performance event based on preset verification basic conditions.

Herein, the verification basic conditions according to an embodiment may include a condition for satisfying the aforementioned participation place conditions, and a condition for satisfying a predetermined minimum period of time (for example, a specific 10-minute period within the main viewing time) in which the participation time condition is included in the main viewing time (in other words, the performance time of the target information).

In other words, the verification basic conditions may be verification conditions that set the minimum requirements for verifying that a user has attended the target performance event.

In addition, in an embodiment, the application 111 may perform capturing control based on image sensor 161 control when attendance verification (hereinafter, attendance basic verification) according to the verification basic conditions is approved.

In more detail, in an embodiment, the application 111 may perform capturing control to restrict or permit capturing based on the image sensor 161 based on a preset capturing restriction section when the attendance basic verification is approved.

As an example, the application 111 may set a capturing restriction section that restricts camera capturing based on the performance time of the target performance event.

For example, when the performance time of the target performance event is “2:00 p.m. to 4:00 p.m. ,” the application 111 may set a predetermined section (for example, 2:00 p.m. to 3:30 p.m.) within the performance time as a capturing restriction section.

In addition, in an embodiment, the application 111 may control the image sensor 161 to limit the capturing function when the real-time time enters the capturing restriction section while the target performance event is in progress.

In addition, in an embodiment, the application 111 may control the image sensor 161 to release the restriction on the capturing function, in other words, permit the capturing function, when the capturing restriction section ends (in other words, when the capturing restriction section is exceeded).

In other words, the application 111 may regulate the performance capturing via a camera during a preset capturing restriction section and allow capturing in other sections when the attendance basic verification as described above is approved. Thus, when capturing of some sections of a specific performance event needs to be restricted for reasons such as copyright or security, the capturing thereof may be easily and reliably restricted through an automated process without having to individually monitor or control the performance audience.

In addition, in an embodiment, the application 111 may provide a reward according to the attendance verification (S109).

In detail, in an embodiment, the application 111 may provide a predetermined NFT reward when online/offline attendance verification is approved according to the preset verification conditions as in stage S105 described above.

Herein, the NFT reward according to an embodiment may mean a reward provided based on the NFT, which is a unique digital file format registered on a blockchain.

For reference, the NFT refers to a virtual token that proves the ownership of a digital asset using blockchain technology, and may be a type of virtual certificate of authenticity used to indicate its unique originality and ownership by including an address indicating a digital file such as a predetermined image or video in a token. The NFT might have the advantage that its economic value might gradually increase over time.

In other words, in an embodiment, the application 111 may provide the NFT reward as described above when the attendance verification of a user for the target performance event is approved according to the aforementioned verification conditions (in an embodiment, the participation place conditions and the participation time conditions).

In this connection, depending on an embodiment, the application 111 may provide the NFT reward when additional preset reward conditions are met.

As an example, the additional reward condition may include a condition of departing from the target place according to the participation place condition by a predetermined criterion (for example, a preset distance) after approval of participation verification according to the verification condition.

In other words, according to an embodiment, the application 111 may support providing the NFT reward only when a user leaves the performance place by a predetermined criterion (for example, a predetermined distance) after viewing the target performance event.

Thus, the application 111 may prevent in advance systemic errors such as communication load or errors that may occur when NFT rewards are issued to all viewers in lump sum within a single performance place, thereby improving the quality of the service and also increasing user satisfaction.

Returning to the above, in more detail, in an embodiment, the application 111 may create the NFT reward described above.

In this connection, in an embodiment of the present disclosure, the method for creating the NFT may be implemented based on at least one known algorithm. The NFT creation algorithm is not limited or restricted. Hereinafter, the following mainly describes contents specific to an embodiments of the present disclosure.

In an embodiment, the application 111 may create the NFT reward by including predetermined digital content (for example, predetermined digital images, videos, and/or audio sources) related to the target performance event.

For example, the digital content may be an image, video and/or audio source of an artist (or group of artists) of the target performance event, or a performance highlight image, video and/or audio source of the target performance event.

In addition, according to an embodiment, the application 111 may create the NFT reward by including a personal user image directly captured through the image sensor 161 during a section other than the aforementioned capturing restriction section (hereinafter, a capturing permission section).

In detail, in an embodiment, the application 111 may share personal user videos captured by a plurality of users based on the attendance verification reward service platform.

In addition, in an embodiment, the application 111 may conduct a voting process for a plurality of personal user videos shared on the platform.

In addition, the application 111 may select at least one personal user video that satisfies a predetermined criterion (for example, the highest number of votes or the number of votes greater than or equal to a preset percentage (%)) as a result of the voting.

In addition, the application 111 may create the NFT reward based on at least one selected personal user image.

In addition, according to an embodiment, the application 111 may provide a predetermined winning reward (for example, an NFT including the personal user image) to at least one user who captured the selected personal user image.

Accordingly, the application 111 may create and provide a rare NFT reward using realistic videos captured by audience members attending the target performance event, thereby further stimulating the user interest and curiosity in viewing the performance and inducing more active participation therein.

Returning again, in an embodiment, the application 111 may also provide a user with the NFT reward created as above.

In this connection, in an embodiment, the application 111 may create and provide offline customized NFT rewards when providing NFT rewards according to offline performance attendance verification.

In detail, in an embodiment, the application 111 may create offline customized NFT rewards that include digital content specific to a user who attended an offline performance.

Herein, the user-specific digital content according to an embodiment may mean digital content that has a unique form and is specific for each user.

In an embodiment, such user-specific digital content may be predetermined images (in other words, images and/or videos) captured targeting users who attended the offline performance.

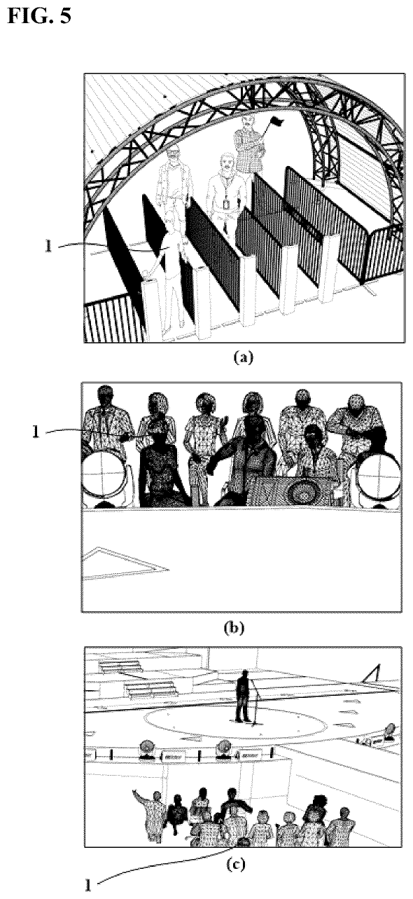

FIG. 5 is an example of user-specific digital content according to an embodiment of the present disclosure.

For example, referring to FIG. 5, the user-specific digital content may include a user entry scene capturing video (a) in which a user 1 enters the entrance of the offline performance venue, a user viewing scene capturing video (b) in which the user 1 views the performance from his/her seat, and/or a user viewpoint capturing video (c) captured from the direction of the performance stage from the direction of the seat of the user 1.

In more detail, in an embodiment, the application 111 may obtain user-specific digital content as described above by linking with at least one camera (for example, CCTV and/or a predetermined performance capturing equipment) disposed at the offline performance place.

Specifically, in an embodiment, the application 111 may obtain installation location information for at least one camera (hereinafter, “on-site camera”) disposed in the offline performance place by linking with an external server (for example, the service providing server 200).

In addition, in an embodiment, the application 111 may sense the on-site camera existing within a predetermined range (for example, a radius of 5 m) based on user location information obtained in real time.

In addition, in an embodiment, the application 111 may perform data communication with the sensed on-site camera to receive and obtain the user-specific digital content captured through the on-site camera.

In an embodiment, the application 111 may create the offline customized NFT reward by including at least a portion of the user-specific digital content obtained as described above.

In addition, in an embodiment, the application 111 may provide the created offline customized NFT reward to a user upon approval of offline performance attendance verification according to the verification conditions.

As such, the application 111 creates an NFT reward (in other words, an offline customized NFT reward in an embodiment) that includes at least a portion of user-specific digital content implemented based on predetermined images and/or videos captured targeting users who attended an offline performance, and provides the same as a reward to the user when the offline performance attendance verification is approved, thereby providing an NFT that is highly specialized for each user as a reward, thereby further increasing its rarity and value, and thereby enhancing user needs for the offline customized NFT reward, thereby encouraging the desire to view the performance, and also enhancing user satisfaction and service quality by allowing users who received the offline customized NFT reward to recall their memories and experiences of viewing the offline performance more vividly.

In addition, in an embodiment, the application 111 may provide a new reward according to a plurality of pieces of attendance verification (S111).

Herein, the new reward according to an embodiment may mean an NFT reward newly obtained as the plurality of pieces of attendance verification is approved.

In an embodiment, the new reward may include additional NFT rewards and/or higher-tier NFT rewards.

Herein, the additional NFT reward according to an embodiment may be an NFT reward additionally obtained when the plurality of pieces of attendance verification for a plurality of pre-designated performance events are approved.

In addition, the higher-tier NFT reward according to an embodiment may be an NFT reward obtained when a plurality of NFT rewards obtained by the approval of the plurality of pieces of attendance verification are successfully synthesized (combined/reinforced) according to a predetermined criterion.

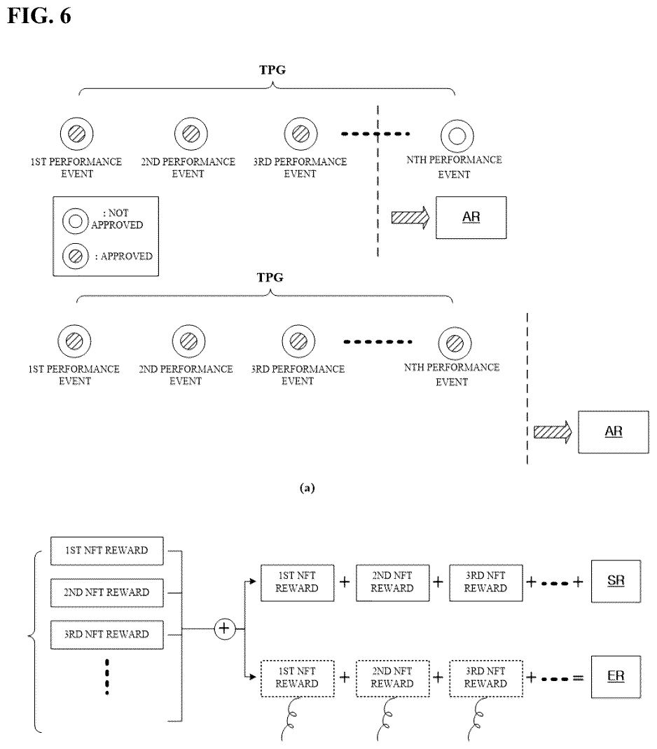

FIG. 6 is a conceptual diagram illustrating a method for providing a new reward according to an embodiment of the present disclosure.

In detail, referring to FIG. 6(A), in an embodiment, the application 111 may provide the additional NFT reward (AR) when 1) the plurality of pieces of attendance verification for the plurality of pre-designated performance events (TPG: hereinafter, target performance event group) are approved.

In this connection, the target performance event group (TPG) may be, for example, a set of the 1st to Nth performance events according to a national tour and/or world tour of a predetermined artist (or artist group).

In addition, the additional NFT reward (AR) herein may be an NFT reward additionally provided in addition to the existing NFT reward when the plurality of pieces of attendance verification for the target performance event group (TPG) are approved.

In more detail, in an embodiment, the application 111 may determine whether the number of attendance verification approvals for a plurality of performance events included in the target performance event group (TPG) meets a predetermined criterion (for example, more than a preset number of times or the total number of times).

In addition, the application 111 may provide a user with additional NFT rewards (AR) as described above when the predetermined criterion is met.

In other words, the application 111 may encourage users to participate in performance events and induce activation of the performance market by providing additional rewards when the attendance verification of the users for at least some of a set of pre-designated performance events (for example, a plurality of concerts for a specific tour) is approved, and may support appropriate management of heavy users by providing appropriate rewards for more active and vibrant participation.

Referring to FIG. 6(B), in an embodiment, the application 111 may 2) provide an upgrade function that synthesizes (combines/reinforces) a plurality of NFT rewards (MR: hereinafter, a plurality of material NFTs) obtained as a plurality of pieces of attendance verification is approved according to a predetermined method, and may provide the higher-tier NFT reward when the upgrade is successful.

In this connection, for example, the predetermined method may be a preset artist, artist group and/or synthesis condition (for example, related to a specific concert and/or tour).

In addition, the higher-tier NFT reward herein may be a rarer (higher value) NFT with a lower acquisition probability compared to the plurality of material NFTs (MR).

In an embodiment, the higher-tier NFT reward may include an additional NFT upper reward (SR) provided in addition to the plurality of material NFTs (MR) upon successful upgrade and/or a single NFT upper reward (ER) provided when the plurality of material NFTs (MR) are discarded upon successful upgrade.

In detail, in an embodiment, the application 111 may determine a plurality of material NFTs (MR) on which the upgrade is to be performed based on user input and/or automated self-processes (for example, as a plurality of pieces of attendance verification is approved, a plurality of NFT rewards owned by a user is determined to be capable of synthesis (combination/reinforcement) according to the predetermined method).

In addition, in an embodiment, the application 111 may perform an upgrade on the plurality of material NFTs (MR) by executing a synthesis (combination/reinforcement) process based on the determined plurality of material NFTs (MR).

In addition, in an embodiment, the application 111 may provide a user with an higher-tier NFT reward as described above when the upgrade is successful.

In other words, in an embodiment, when the upgrade through synthesis (combination/reinforcement) of the plurality of material NFTs (MR) is successful, the application 111 may provide an NFT having a higher value than the plurality of material NFTs (MR) as a reward.

As such, the application 111 enables synthesize (combine/reinforce) a plurality of material NFTs (MR) to use for an upgrade among a plurality of NFT rewards owned by a user through a plurality of attendance verification approvals in a predetermined method, thereby providing a new reward accordingly, thereby providing a higher motivation for collecting NFT rewards according to attendance verification, and thereby further enhancing the user needs and desires for viewing performance events.

Hereinbefore, the method for providing the reward according to the attendance verification and the system therefor according to an embodiment of the present disclosure can verify user attendance for performance events held online and offline, thereby clearly identifying the user attendance and viewing not only of offline but also online performance events, and thereby improving the accuracy and reliability of user attendance verification for the performance events held in spaces encompassing online and offline.

In addition, the method for providing the reward according to the attendance verification and the system therefor according to an embodiment of the present disclosure can implement a differentiated reward paradigm that can more effectively increase user satisfaction with rewards by providing a predetermined NFT reward according to the approval of the attendance verification, thereby further encouraging user participation in performance events and thereby promoting the activation of the performance market.

In addition, the method for providing the reward according to the attendance verification and the system therefor according to an embodiment of the present disclosure can provide customized NFT rewards specialized for each user, thereby further improving user satisfaction with rewards and simultaneously increasing user needs and desires for participation in performance events, thereby inducing more active performance viewing.

The embodiments of the present disclosure described above may be implemented in the form of program instructions which may be executed through various types of computer constituting elements and recorded in a computer-readable recording medium. The computer-readable recording medium may include program instructions, data files, and data structures separately or in combination thereof. The program instructions recorded in the computer-readable recording medium may be those designed and configured specifically for the present disclosure or may be those commonly available for those skilled in the field of computer software. Examples of a computer-readable recoding medium may include magnetic media such as hard-disks, floppy disks, and magnetic tapes; optical media such as CD-ROMs and DVDs; and hardware devices specially designed to store and execute program instructions such as ROM, RAM, and flash memory. Examples of program instructions include not only machine codes such as those generated by a compiler but also high-level language codes which may be executed by a computer through an interpreter and the like. The hardware device may be replaced with by one or more software modules to perform the operations of the present disclosure, and vice versa.

### INDUSTRIAL APPLICABILITY

An embodiment of the present disclosure relates to a method for verifying attendance through a terminal and providing an NFT as a reward therefor, and thus has industrial applicability.

What is claimed is:

1. A method for providing a reward according to attendance verification, in which an attendance verification reward application executed by at least one processor of a terminal provides the reward according to the attendance verification, the method comprising:
obtaining ticket information comprising performance time and performance place information about an offline or online performance event;
obtaining activity status information comprising at least one of from among offline real-time location information and online real-time viewing history information of a user;
verifying attendance of the performance event based on the ticket information and the activity status information; and
providing a non-fungible token (NFT) reward according to the attendance verification.

2. The method of claim 1, wherein the NFT reward is a reward provided based on an NFT, a digital file registered on a blockchain.

3. The method of claim 1, wherein the verification of the attendance of the performance event comprises verifying the attendance based on verification conditions comprising a participation place condition that sets a target place for approving the attendance verification for the performance event, and a participation time condition that sets a target viewing time for approving the attendance verification for the performance event.

4. The method of claim 3, wherein the verification of the attendance of the performance event comprises:
verifying offline attendance based on the ticket information, the real-time location information, and the verification conditions when the performance event is an offline performance event; and
verifying online attendance based on the ticket information, the real-time viewing history information, and the verification conditions when the performance event is an online performance event.

5. The method of claim 2, wherein the provision of the NFT reward according to the attendance verification comprises creating the NFT reward comprising predetermined digital content.

6. The method of claim 5, wherein:
the provision of the NFT reward according to the attendance verification further comprises providing an offline customized NFT reward according to the attendance verification for an offline performance event; and
the creation of the NFT reward comprising the digital content comprises creating the offline customized NFT reward based on user-specific digital content comprising a video captured targeting a user who attended the offline performance event.

7. The method of claim 2, further comprising providing a new NFT reward according to a plurality of pieces of attendance verification.

8. The method of claim 7, wherein the provision of the new NFT reward according to the plurality of pieces of attendance verification comprises providing a predetermined additional NFT reward when the plurality of pieces of attendance verification based on a plurality of pre-designated performance events are approved.

9. The method of claim 7, wherein the provision of the new NFT reward according to the plurality of attendance verification comprises:
providing an upgrade function for synthesizing a plurality of NFT rewards provided according to the plurality of pieces of attendance verification approved according to a predetermined criterion; and
providing a predetermined higher-tier NFT reward when the synthesis is successful.

10. The method of claim 2, further comprising:
verifying the attendance based on verification basic conditions comprising minimum attendance verification requirements; and
performing capturing control to restrict or permit camera capturing when the attendance verification according to the verification basic conditions is approved.

11. The method of claim 10, wherein the performance of the capturing control comprises performing the capturing control based on a preset capturing restriction section.

12. The method of claim 11, wherein the provision of the NFT reward according to the attendance verification comprises creating the NFT reward comprising a user personal video captured in a section other than the capturing restriction section.

13. A system for providing a reward according to attendance verification, the system comprising:
at least one memory in which an attendance verification reward application is stored; and
at least one processor for reading out the attendance verification reward application stored in the memory and providing the reward according to the attendance verification;
wherein instructions of the attendance verification reward application comprise instructions for:
obtaining ticket information comprising performance time and performance place information about an offline or online performance event;
obtaining activity status information comprising at least one of from among offline real-time location information and online real-time viewing history information of a user;
verifying attendance of the performance event based on the ticket information and the activity status information; and
providing a non-fungible token (NFT) reward according to the attendance verification.
